(19) United States
(12) Patent Application Publication
(10) Pub. No.: US 2008/0126787 A1
(43) Pub. Date: May 29, 2008

(54) System, method and program for managing default values for computer programs

(75) Inventors: Rhonda L. Childress, Austin, TX (US); Oded Dubovsky, Haifa (IL); Itzhack Goldberg, Hadera (IL); Ido Levy, Kiryat Motzkin (IL); Ziv Rafalovich, Yokneam (IL); Martin J. Tross, Haifa (IL)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/446,836

(22) Filed: Jun. 5, 2006

(51) Int. Cl. G06F 1/24

(52) U.S. Cl. 713/100

(57) ABSTRACT

Managing default values. A determination is automatically made that the first program is operating in the batch mode in which user interaction is not intended to affirm or change default values. In response, first current default values for input to the first program are determined, and a determination is made whether a user previously entered or affirmed the first current default values in an interactive mode. If so, the first program is allowed to proceed with operation using the first current default values. If not, the first program is not allowed to proceed with operation using the first current default values. A determination is automatically made that the second program is operating in the interactive mode in which user interaction is intended to affirm or change default values. In response, second current default values for input to the second program are determined, the second current default values are presented to a current user, and a determination is made that a user previously entered or affirmed the second current default values. If the current user does not affirm or change the second current default values within a time-out period, the second program is allowed to proceed with operation using the second current default values. If the current user affirms or changes the second current default values, the second program is allowed to proceed with operation using the affirmed or changed second default values, respectively.

### FIELD OF THE INVENTION

The present invention relates,generally to computer systems, and more specifically to management of default values for input to computer systems and programs.

### BACKGROUND OF THE INVENTION

Computer systems and programs often use default values for various types of input. With a default value, there is no need for the user to repeatedly enter the value each time the system boots-up or the program initiates. Also, the default value serves as a guide for the type of input that is required, in the event the user wants to override the default value. For example, various BIOS systems allow the user to press the PF1 key and override default values (within a time-out period). As another example, an AIX Smitty program displays default values and allows a user to change them. Typically, the default value is presented to the user on a computer screen, and the user is given the opportunity to either accept or reject the default value. In the latter case, the user enters a substitute value for the default value. The substitute value can either persist, i.e. appear during the next invocation of the system or program or be a one-time value, i.e. be used only during the current invocation of the system or program. In the latter case, during the next invocation of the system or program, the original default value will be displayed for the user to accept, reject or replace. If the user does not override a default value within a predetermined period, it was known in some systems and programs such as the BIOS system to proceed with the default value and in other systems and programs to not proceed.

Default values can be set in a variety of known manners, such as the following. The system or program requiring the default value can specify an original default value based on “hard code” or a reference to a file defined by the programmer. This is typical where the programmer has a good idea of what the default value should be. Alternately, the system or program requiring the default value can determine the original default values based on the output of a certain command. For example, a command “hostname” can be used to retrieve the host name instead of an interaction with the user. This is typical where the default values are expected to vary, for example, when they involve characteristics or preferences of a user.

An object of the present invention is to better manage default values.

### SUMMARY OF THE INVENTION

The present invention resides in a system, method and program for managing default values for a first program in a batch node in which user interaction is not intended to affirm or change default values, and managing default values for a second program in an interactive mode in which user interaction is intended to affirm or change default values. A determination is automatically made that the first program is operating in the batch mode. In response, first current default values for input to the first program are determined, and a determination is made whether a user previously entered or affirmed the first current default values in an interactive mode. If so, the first program is allowed to proceed with operation using the first current default values. If not, the first program is not allowed to proceed with operation using the first current default values. A determination is automatically made that the second program is operating in the interactive mode. In response, second current default values for input to the second program are determined, the second current default values are presented to a current user, and a determination is made that a user previously entered or affirmed the second current default values. If the current user does not affirmatively affirm or change the second current default values within a time-out period, the second program is allowed to proceed with operation using the second current default values. If the current user affirms or changes the second current default values, the second program is allowed to proceed with operation using the affirmed or changed second default values, respectively.

### BRIEF DESCRIPTION OF THE FIGURES

FIG. 1 is a block diagram of a computer system which includes a default value management program according to the present invention.

FIG. 2 is a flow chart of a set up phase of the default value management program of FIG. 1.

FIG. 3 is a flow chart illustrating function and operation of the default management program in an interactive mode.

FIG. 4 is a flow chart illustrating function and operation of the default management program in a batch mode.

### DETAILED DESCRIPTION OF THE PREFERRED EMBODIMENTS

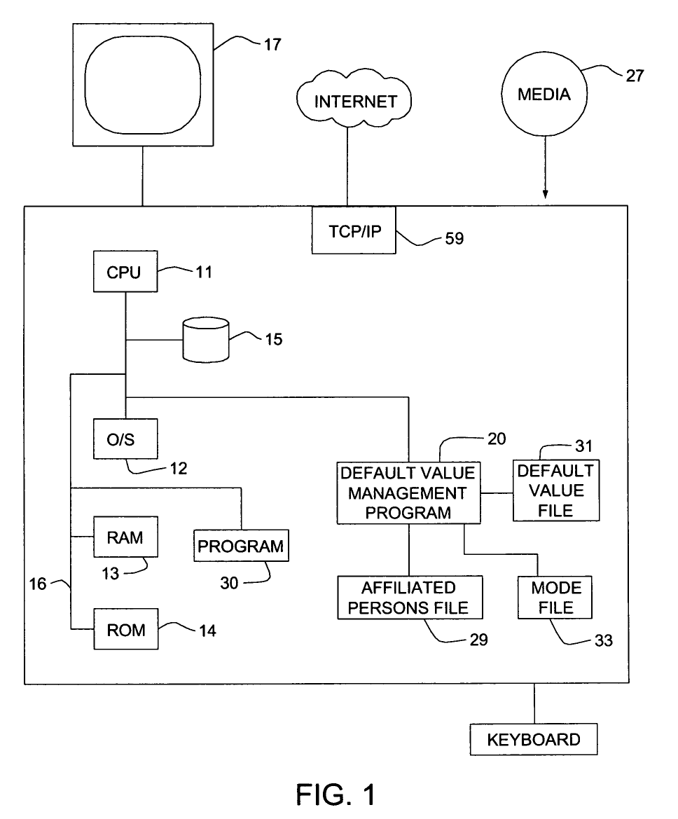

The present invention will now be described in detail with reference to the figures. FIG. 1 illustrates a computer 10 which includes a known CPU 11, operating system 12, RAM 13, and ROM 14 interconnected via a bus 16 and display screen 17 and storage 15. Computer 10 also includes a known application or other program 30 such as a BIOS program, for which default values are required. Computer 10 also includes a default value management program 20 according to the present invention, for use by program 30 and other programs as well. Optionally, program 20 can be a part of program 30 that executes before the main function of program 30.

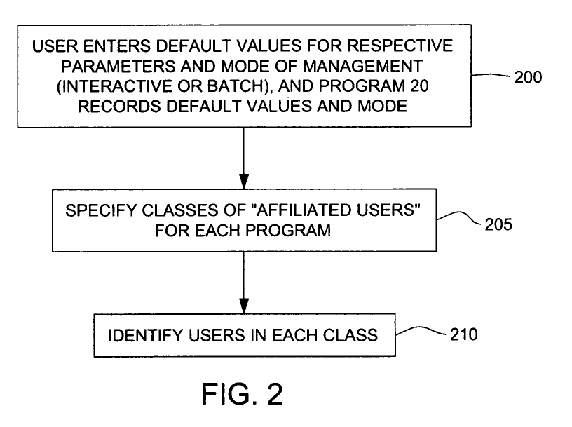

FIG. 2 is a flow chart illustrating a setup phase of program 20. In step 200, a user enters default values for each parameter/type of input required to execute the program. Also in step 200, the user specifies whether the default value will be managed in an interactive mode or a batch mode. In the interactive process, a user will be prompted during each invocation of the program to review the default value as described above. During a batch process, the user will not be prompted during the program invocation to review the default value as described above, and if the program's configuration file was never “approved” by an authorized person (for example, during an interactive session) the batch invocation will fail. The interactive and batch modes are described in more detail below. Program 20 records the mode specification in Mode file 33. Each default value can be system wide, specific to each customer or specific to a geographic domain. In step 205, a user specifies which classes of people have authority or “affiliation” to affirmatively accept or update a current/existing default value. For example, a senior system administrator (class), who is responsible for configuring the system and customizing the system for a customer, may be “affiliated” with program 30 and have the authority to affirmatively accept or update a current default value. However, a junior system administrator (class), who administers program 30 after it has been fully tested and configured for the system and customer, may not have authority to affirmatively accept or update a current default value. Each person's affiliation and therefore right to affirmatively accept or update a current default value may be limited to invocation of program 20 for all customers or just specific customers. In step 210, the user assigns user IDs to members of each class in an affiliated persons file 29. If the roles of each class are specific to specific customers, then the same user ID can be in a different class, and therefore have different roles with different customers.

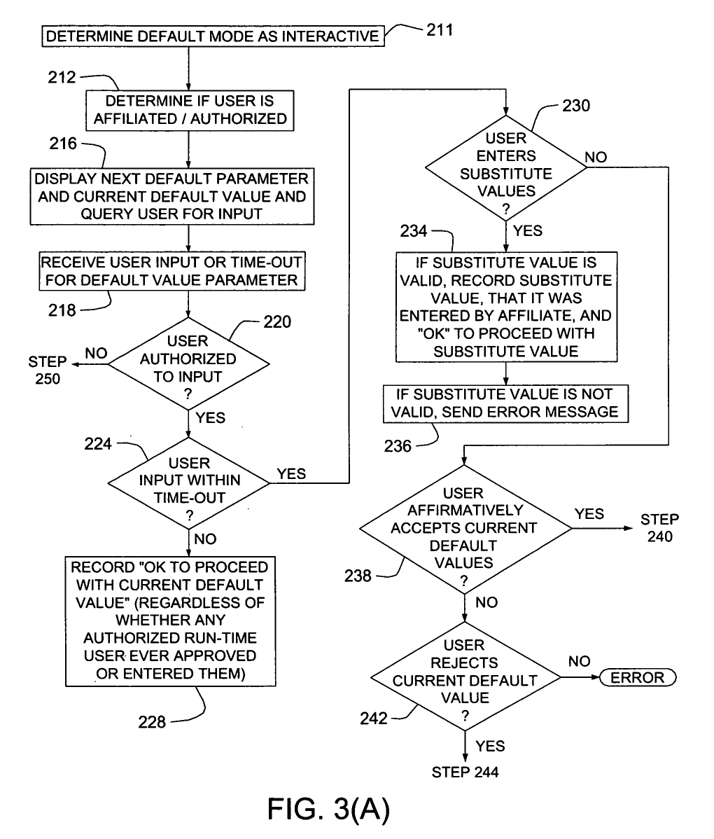

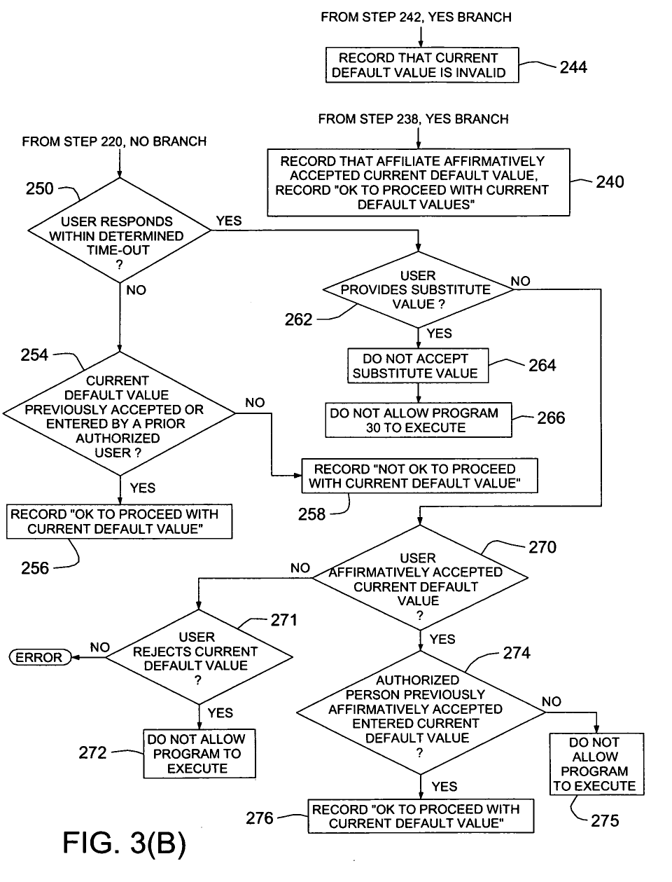

FIG. 3 illustrates function and operation of program 20 in the interactive mode (decision 211). In the interactive mode, program 20 first determines if the user is affiliated (i.e. authorized to input or accept default values) with the workstation or terminal being used to control the default values (step 212). A user is “affiliated” if the user is the owner or registered user or administrator of the workstation or otherwise recognized as someone with authority to accept, reject or change default values. Program 20 determines if the user is affiliated with the workstation by comparing a valid user ID of the user to a list of owners, registered users, administrators or other authorized people listed in affiliated persons file 29 by their respective user IDs. Next, in the interactive mode, program 20 displays a current default values for program 30, and prompts or queries the user to affirmatively accept, reject or change the current default values (step 216). The current default values can either be original default values or substitute default values subsequently specified by an affiliated user. The original default values can be hard coded into program 30 or specified in a default value file 31 associated with program 30 and accessible by program 20. (If there are both hard coded default values and default values in a default value file 31, then the default values in the default value file take precedence as the actual default values.) Program 20 displays the current default value and respective parameter to the user, either via a graphical user interface or a command line interface. Program 20 displays the current default value and waits a predetermined time, such as ten seconds, for the user to accept, reject or specify substitute default values (step 218). Program 20 will only accept substitute default values from an affiliated user.

If the current user is affiliated/authorized with the workstation (and is operating in an “interactive” mode) (decision 220, yes branch):
1. if the current user does not respond within the predetermined time-out period (decision 224, no branch), program 20 will allow program 30 to proceed with the current default values regardless of whether the current default values have ever been affirmatively accepted by an affiliated person and therefore, records that the current default value is valid. (step 228).
2. if the current user responds within the predetermined time-out period (decision 224, yes branch) and enters valid substitute default values (decision 230, yes branch), program 20 will allow program 30 to proceed with the substitute default values and records the substitute values in the default value file 31 and that the current default value is valid (step 234). (In the illustrated embodiment of the present invention, the substitute default values are applicable regardless of a domain in which they were created. The domain can be geographical, organizational within a company or based on any other domain which can be determined programmatically. In another embodiment of the present invention, the substitute default values are applicable only in the domain in which they were created. In this other embodiment, program 20 records the applicable domain in association with the respective substitute default values.) In step 234, program 20 checks that the default value is valid by checking that it is complete and has proper syntax, length, type (alpha, numeric, etc.), structure or valid selection from a group. If not, then program 20 sends an error message to the user (step 236). In one embodiment of the present invention, these substitute default values automatically replace the current default values for subsequent invocations of program 30. In another embodiment of the present invention, the current user can either specify these as persistent default values, in which case they will replace the current default values for subsequent invocations of program 30, or one-time default values in which case they will not replace the current default values for subsequent invocations of program 30.
3. if the current user;responds within the predetermined time-out period (decision 224, yes branch) and accepts the current default values (decision 238, yes branch), program 20 will allow program 30 to proceed with the current default values and records in default value file 31 that the current default value has been accepted by an affiliated person and is valid (step 240).
4. if the current user responds within the predetermined time-out period (decision 224, yes branch) and rejects the current default values (decision 242, yes branch), program 20 will not allow program 30 to proceed with the current default values and records that the current default value are not valid (step 244).

If the current user is not affiliated/not authorized with the workstation (decision 220, no branch), then program 20 will not allow program 30 to proceed unless the current default values were previously affirmatively accepted or entered from an affiliated user. An affiliated person could have affirmatively accepted the current default values previously by pressing an enter key when they are highlighted or selecting them with a mouse. An affiliated person could have entered the current default values by overwriting the original or prior default values during a prior interactive session. So, if the current user is not affiliated with the workstation (decision 220, no branch) (and is operating in an interactive mode):
1. if the current user responds within the predetermined time-out period (decision 250, yes branch) and enters substitute default values (decision 262, yes branch), program 20 will not accept the substitute default value (step 264), and not allow program 30, to proceed with the substitute default values and record that the current default value is not valid (step 266).
2. if the current user does not respond within the predetermined time-out period (decision 250, no branch), program 20 determines if the current default values were affirmatively accepted or were previously entered by an affiliated person, at least once before (decision 254). If so (decision 254, yes branch), then program 20 will allow program 30 to proceed with the current default values only and record that the current default value is valid (step 256). If not (decision 254, no branch), then program will not allow program 30 to proceed with the current default value and will record that the current default value is invalid (step 258).
3. if the current user responds within the predetermined time-out period (decision 250, yes branch) and affirmatively accepts the current default values (decision 270, yes branch), then program 20 determines if the current default values were affirmatively accepted by an affiliated person, at least once before (decision 274). If so (decision 274, yes branch), program 20 will allow program 30 to proceed with the current default values and record that the current default value is valid (step 276). If not (decision 274, no branch), program 20 will not allow program 30 to execute (step 275). Referring again to decision 270, no branch, if the current default values were rejected by the current user (decision 271, yes branch), then program 20 will not allow program 30 to execute (step 272).

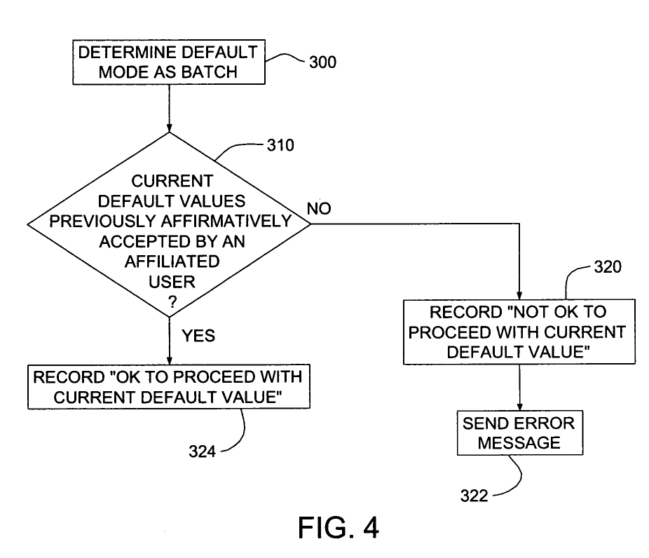

FIG. 4 illustrates function and operation of program 30 in the batch mode (decision 300). In the batch mode, program 20 will allow program 30 to proceed with the current default values only if the current default values were previously affirmatively accepted or entered/substituted by an affiliated user during an interactive session (when the mode was “interactive”). If an affiliated user did not previously affirmatively accept the current default values, then program 20 will not allow program 30 to proceed with the current default values and will display an error message. In the batch mode, there may or may not be a current user, and program 20 does not consider the presence or absence of a current user in deciding whether to allow program 30 to proceed with the current default values. Program 20 can determine whether program 30 is operating in an interactive mode or a batch mode by executing a known utility such as “tty-s” for Unix computers. So, in decision 310, program 20 determines from default value file 31 if the default values were previously affirmatively accepted by an affiliated person or were entered by an affiliated person. If so (decision 310, yes branch), program 20 records that the current default value is valid and that program 30 can proceed with the current default value (step 324). If not (decision 310, yes branch), program records that the current default value is not valid and that program 30 cannot proceed with the current default value (step 320), and then sends an error message to the user (step 322).

Program 20 can be loaded into computer 10 from a computer readable media 27 such as a magnetic tape or disk, optical media, DVD, semiconductor memory, memory stick, etc. or downloaded from the Internet via TCP/IP adapter card 59.

Based on the foregoing, a system, method and program product for managing default values have been disclosed. However, numerous modifications and substitutions can be made without deviating from the scope of the present invention. Therefore, the present invention has been disclosed by way of illustration and not limitation, and reference should be made to the following claims to determine the scope of the present invention.

What is claimed:

1. A computer implemented method for managing default values for a first program in a batch node in which user interaction is not intended to affirm or change default values, and managing default values for a second program in an interactive mode in which user interaction is intended to affirm or change default values, said method comprising the steps of:
automatically determining that said first program is operating in the batch mode, and in response, determining first current default values for input to said first program, determining whether a user previously entered or affirmed said first current default values in an interactive mode and
if so, allowing said first program to proceed with operation using said first current default values, and
if not, not allowing said first program to proceed with operation using said first current default values;
automatically determining that said second program is operating in the interactive mode, and in response, determining second current default values for input to said second program, presenting said second current default values to a current user, and determining that a user previously entered or affirmed said second current default values and
if said current user does not affirm or change said second current default values within a time-out period, allowing said second program to proceed with operation using said second current default values, and
if said current user affirms or changes said second current default values, allowing said second program to proceed with operation using said affirmed or changed second default values, respectively.

2. A computer implemented method as set forth in claim 1 further comprising the step of determining that said current user in said interactive mode is authorized to affirm or change said second current default values.

3. A computer implemented method as set forth in claim 1 wherein the step of determining whether a user previously entered or affirmed said first current default values in an interactive mode, comprises the step of determining whether an authorized user previously entered or affirmed said first current default values in an interactive mode.

4. A system for managing default values for a first program in a batch node in which user interaction is not intended to affirm or change default values, and managing default values for a second program in an interactive mode in which user interaction is intended to affirm or change default values, said system comprising:
means for automatically determining that said first program is operating in the batch mode, and in response, determining first current default values for input to said first program, determining whether a user previously entered or affirmed said first current default values in an interactive mode and
if so, allowing said first program to proceed with operation using said first current default values, and
if not, not allowing said first program to proceed with operation using said first current default values; and
means for automatically determining that said second program is operating in the interactive mode, and in response, determining second current default values for input to said second program, presenting said second current default values to a current user, and determining that a user previously entered or affirmed said second current default values and
if said current user does not affirm or change said second current default values within a time-out period, allowing said second program to proceed with operation using said second current default values, and
if said current user affirms or changes said second current default values, allowing said second program to proceed with operation using said affirmed or changed second default values, respectively.

5. A system as set forth in claim 4 further comprising means for determining that said current user in said interactive mode is authorized to affirm or change said second current default values.

6. A system as set forth in claim 4 wherein the means for determining whether a user previously entered or affirmed said first current default values in an interactive mode, comprises means for determining whether an authorized user previously entered or affirmed said first current default values in an interactive mode.

7. A computer program product for managing default values for a first program in a batch node in which user interaction is not intended to affirm or change default values, and managing default values for a second program in an interactive mode in which user interaction is intended to affirm or change default values, said computer program product comprising:
a computer readable media;
first program instructions to automatically determine that said first program is operating in the batch mode, and in response, determine first current default values for input to said first program, determine whether a user previously entered or affirmed said first current default values in an interactive mode and
if so, allow said first program to proceed with operation using said first current default values, and
if not, not allow said first program to proceed with operation using said first current default values; and
second program instructions to automatically determine that said second program is operating in the interactive mode, and in response, determine second current default values for input to said second program, initiate presentation of said second current default values to a current user, and determine that a user previously entered or affirmed said second current default values and
if said current user does not affirm or change said second current default values within a time-out period, allow said second program to proceed with operation using said second current default values, and
if said current user affirms or changes said second current default values, allow said second program to proceed with operation using said affirmed or changed second default values, respectively; and wherein
said first and second program instructions are stored on said media in functional form.

8. A computer program product as set forth in claim 7 further comprising third program instructions to determine that said current user in said interactive mode is authorized to affirm or change said second current default values; and wherein said third program instructions are stored on said media in functional form.

9. A computer program product as set forth in claim 7 wherein the first program instructions to determine whether a user previously entered or affirmed said first current default values in an interactive mode, determine whether an authorized user previously entered or affirmed said first current default values in an interactive mode.
